(19) United States
(12) Patent Application Publication
(10) Pub. No.: US 2015/0204030 A1
(43) Pub. Date: Jul. 23, 2015

(54) Sealcoat System

(71) Applicant: National GlassTech LLC, Fargo, ND (US)

(72) Inventor: Ronald E. LaCoe, West Fargo, ND (US)

(73) Assignee: National GlassTech LLC

(21) Appl. No.: 14/676,222

(22) Filed: Apr. 1, 2015

Related U.S. Application Data
(62) Division of application No. 13/963,290, filed on Aug. 9, 2013.
(60) Provisional application No. 61/726,083, filed on Nov. 14, 2012.

(51) Int. Cl. E01C 19/46; E01C 11/00; C09D 191/00; E01C 19/16; B02C 23/20; C09D 195/00; E01C 23/00; E01C 11/24

(52) U.S. Cl. CPC E01C 19/46; E01C 23/00; E01C 11/005; E01C 11/24; E01C 19/16; B02C 23/20; C09D 195/005; C09D 191/00

(57) ABSTRACT

A sealcoat system for providing a sealcoat that is free of silica. The sealcoat system generally includes providing a sealer, crushed glass, water and an additive, mixing the sealer together with the crushed glass, water and additive to form a sealcoat composition, and applying the sealcoat composition to a road. The crushed glass is preferably comprised of soda-lime glass and is further preferably comprised of container glass used in the production of bottles and jars.

### CROSS REFERENCE TO RELATED APPLICATIONS

I hereby claim benefit under Title 35, United States Code, Section 119(e) of U.S. provisional patent application Ser. No. 61/726,083 filed Nov. 14, 2012. The 61/726,083 application is currently pending. The 61/726,083 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a sealcoat and more specifically it relates to a sealcoat system for providing a sealcoat that is free of silica sand to reduce health risks for individuals exposed to the sealcoat.

2. Description of the Related Art

Any discussion of the related art throughout the specification should in no way be considered as an admission that such related art is widely known or forms part of common general knowledge in the field.

Asphalt is used for constructing a large percentage of the paved roadways, parking lots and residential driveways in the United States. Asphalt generally comprises a combination of aggregates (crushed stone and sand), filler (cement, hydrated lime or stone dust) and a bituminous binder (called asphalt cement or asphalt binder). When used in construction, asphalt has a number of advantages including smoothness when applied, ease of construction and durability. While asphalt construction has a number of advantages, asphalt can begin to break down due to oxidation, exposure to ultraviolet rays and exposure to oil and gas spills. The most common form of asphalt maintenance is the application of an asphalt sealant or sealcoat applied in a thin layer directly on the asphalt surface. Application of sealcoat provides a number of benefits including protecting the asphalt from exposure to oxygen and water, preventing ultraviolet rays from penetrating the asphalt, resisting damage caused by oil or gas spills, smoothing the asphalt surface and restoring the original look and color of the asphalt. Depending upon environmental conditions (sun exposure, temperature variation, amount of moisture) and traffic on the sealcoat, asphalt driveways may require the application of sealcoat every 1 to 3 years. Sealcoat generally comprises a mixture of emulsified asphalt, water, mineral fillers and various other mixtures. Sealcoat can be applied using a squeegee, stiff broom or mechanical sprayers/applicators. Representative sprayers/applicators include those disclosed in U.S. Pat. Nos. 3,533,336; 3,703,856; 3,841,779; 3,940,213; 3,989,403; 4,026,658; 4,302,128; 4,315,700; 4,575,279; 4,688,964; 4,831,958; 5,362,178; 5,735,952; 5,549,457; 6,102,615; and 6,290,428, all of which are herein incorporated by reference.

Conventional sealcoats are comprised of a sealer (coal tar emulsion, asphalt emulsion or oil based), water, silica sand and additives (e.g. rubber latex-based products). Silica sand is used within sealcoats to hide minor surface defects, improve traction for vehicles and improve durability. The silica sand is typically mixed with the sealer, water and additives on the job site to reduce settling of the silica sand within the container. An example composition for a sealcoat for a high traffic area would include 100 gallons of sealer, 30-60 gallons of water, 200-400 pounds of silica sand and 2-5 gallons of additives. Once the silica sand is fully mixed with the water, sealer and additives, the sealcoat composition may be applied directly to the asphalt surface to sealcoat the asphalt surface. It typically takes approximately 24-48 hours before the sealcoat dries sufficiently to allow traffic upon the sealcoat.

While silica sand provides many benefits for sealcoats, it is well-known that silica sand presents significant health risks if not properly handled. Prolonged exposure to silica sand can lead to a chronic condition known as silicosis. Workers handling silica sand must wear respirators or masks to prevent lung irritation. There are also environmental concerns about silica being used in sealcoats.

Because of the inherent problems with using silica sand within sealcoats, there is a need for a new and improved sealcoat that is free of silica sand.

### BRIEF SUMMARY OF THE INVENTION

The invention generally relates to a sealcoat which includes providing a sealer, crushed glass, water and an additive, mixing the sealer together with the crushed glass, water and additive to form a sealcoat composition, and applying the sealcoat composition to a road. The crushed glass is preferably comprised of soda-lime glass and is further preferably comprised of container glass used in the production of bottles and jars.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of a sealcoat being applied to a roadway.

FIG. 2 is a cross sectional view taken along line 2-2 of FIG. 1.

FIG. 3 is a block diagram illustrating the combining of the sealer, crushed glass, water and additive within a mixer to form a sealcoat composition.

FIG. 4 is a flowchart illustrating the overall operation of the present invention forming the sealcoat composition.

FIG. 5 is a flowchart illustrating the overall process of creating the crushed glass for use within the sealcoat.

### DETAILED DESCRIPTION OF THE INVENTION

### A. Overview.

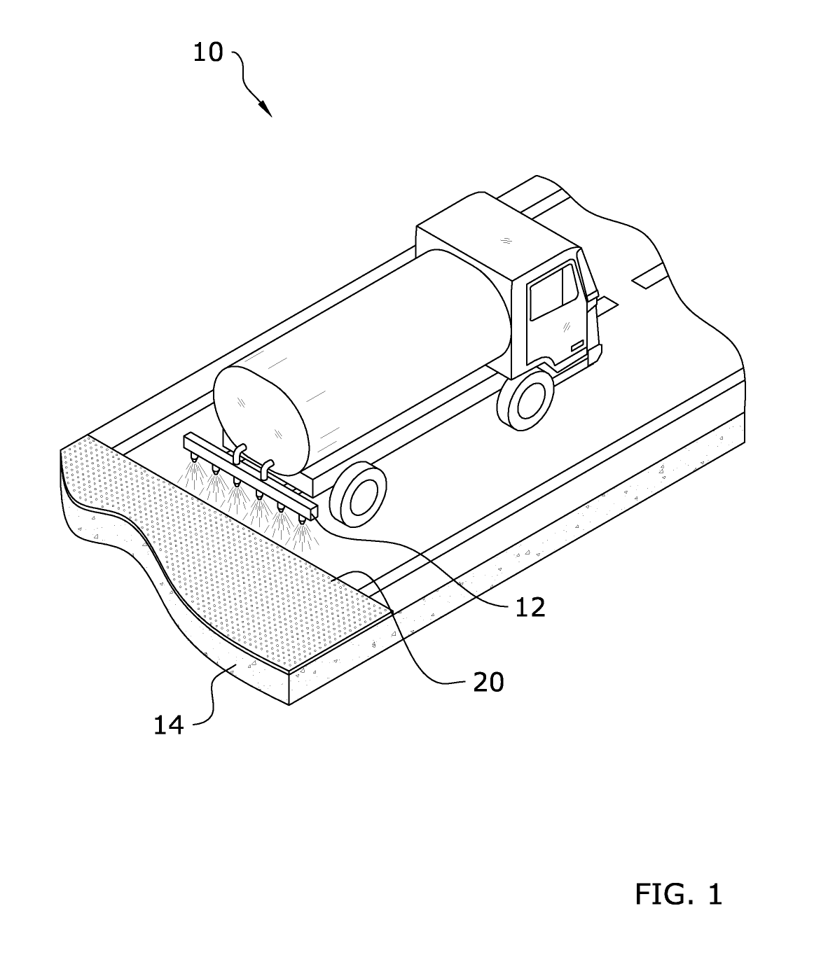

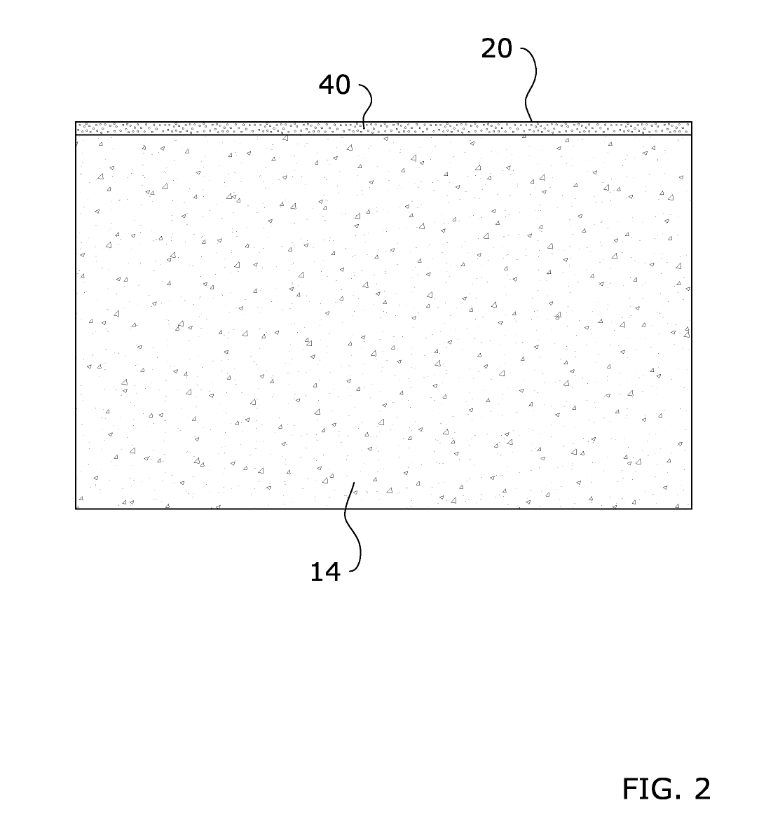

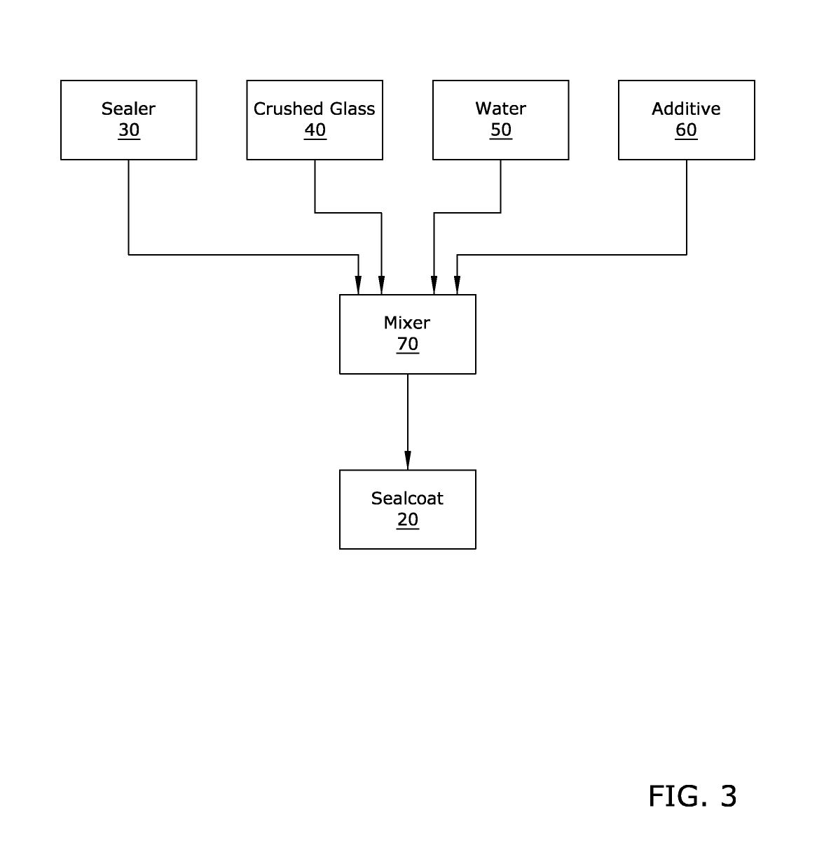

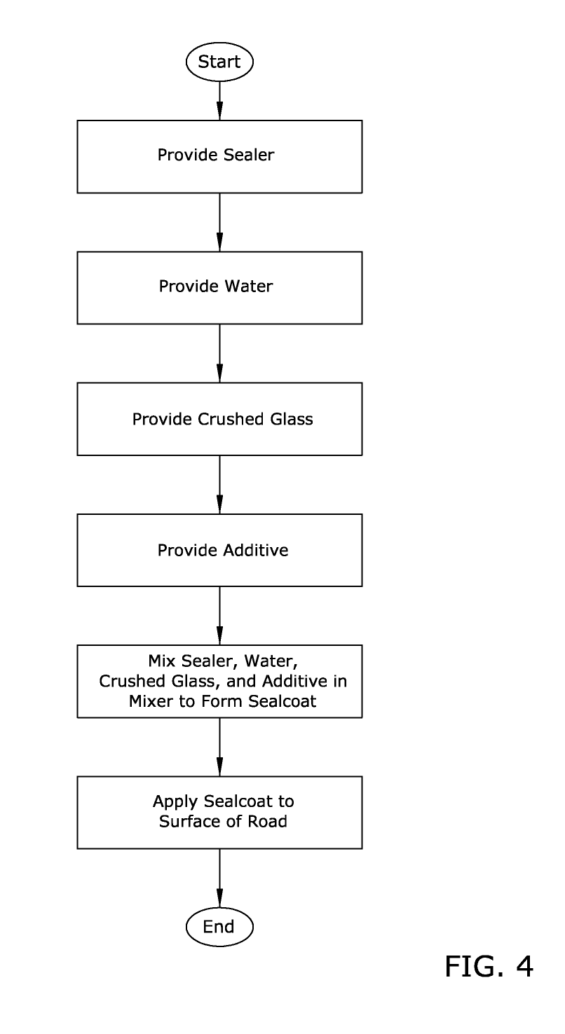

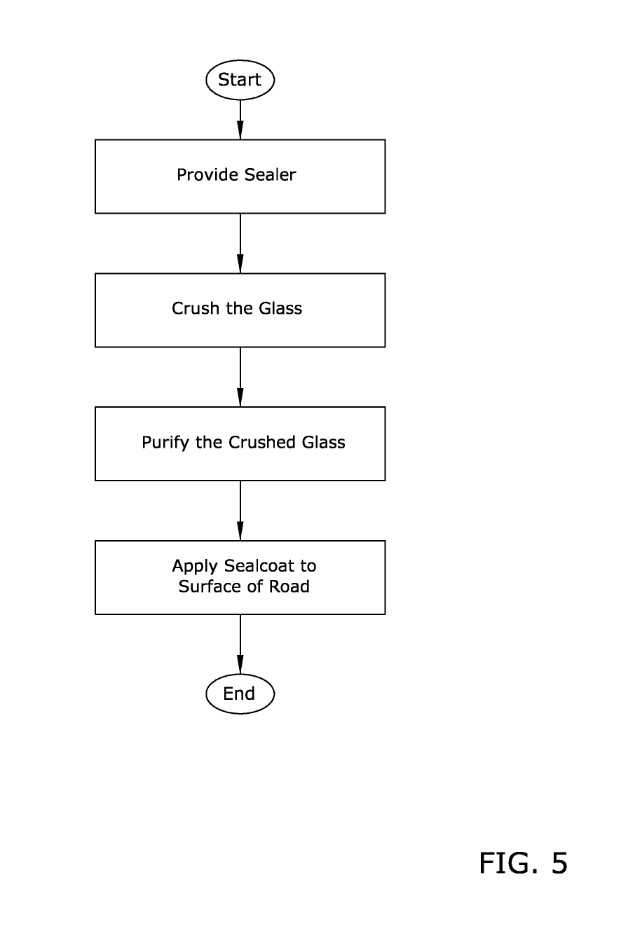

Turning now descriptively to the drawings, in which similar reference characters denote similar elements throughout the several views, FIGS. 1 through 5 illustrate a sealcoat system 10, which comprises providing a sealer 30, crushed glass 40, water 50 and an additive 60, mixing the sealer 30 together with the crushed glass 40, water 50 and additive 60 to form a sealcoat 20 composition, and applying the sealcoat 20 composition to a road 14. The crushed glass 40 is preferably comprised of soda-lime glass and is further preferably comprised of container glass used in the production of bottles and jars. The sealcoat 20 may be applied to various surfaces to seal the same such as but not limited to roads 14 and driveways.

### B. Sealer.

The sealer 30 may be comprised of any conventional sealer 30 used in the sealcoating industry such as but not limited to coal tar emulsion sealer 30, asphalt emulsion sealer 30 or oil based sealer 30. Coal tar emulsion sealer 30 is a durable sealer 30 and is created as a result of the coking process in steel manufacturing. The asphalt emulsion sealer 30 is also a durable sealer 30 that is derived from asphalt (bitumen) and is typically comprised of asphalt, water 50 and a small amount of an emulsifying agent. The oil based sealer 30 is comprised of asphaltic chemicals based with an oil composition. It can be appreciated that various other types of sealer 30 may be utilized.

### C. Additive.

One or more additives 60 may be utilized within the present invention. The additive 60 may be comprised of any conventional additive 60 used in the sealcoating industry such as but not limited to rubber latex-based products. The usage of latex rubberizing additives 60 help suspend the crushed glass 40 within the sealcoat 20 composition while in the liquid state, assists in drying the sealcoat 20 once applied to a road 14, assists with bonding of the sealcoat 20 to the road 14 and increases the useful life of the sealcoat 20 on the surface of a road 14.

### D. Crushed Glass.

The present invention utilizes crushed glass 40 instead of silica sand or crushed sand. The crushed glass 40 is comprised of a plurality of small glass particles. The present invention preferably utilizes recycled glass from discarded bottles, jars and the like. In particular, the crushed glass 40 is preferably formed from soda-lime glass which is divided into two main groups: (a) flat glass (e.g. for windowpanes) produced by a float glass process and (b) container glass (e.g. for glass containers such as bottles, jars, drink ware, pitchers, vases and bowls) produced by blowing and pressing processes.

The crushed glass 40 is preferably comprised of container glass which is typically produced by blowing and pressing techniques. The crushed glass 40 is further preferably comprised of recycled container glass (cullet) that is produced by crushing glass containers such as bottles and jars. The crushed glass 40 preferably does not include any flat glass.

The glass is crushed by a conventional glass crusher that pulverizes the glass to a desired size such as 360 mils. The crushed glass 40 typically will have a size of between 20 to 75 mesh AFS (American Foundrymen Specification) depending upon the surface to be sealed. Glass crushers have been utilized within glass recycling operations for years and typically include screens and separators to separate the crushed glass 40 based on the size thereof. Glass crushers are similar to rock crushers. One example of a glass crusher used in the glass recycling industry is the vertical shaft impactor (VSI) glass crusher which provides large scale glass crushing up to 125 tons per hour of crushed glass 40 cullet. U.S. Pat. No. 5,289,980 to Shinpo illustrates an exemplary Glass Vessel Crusher and is incorporated by reference into this patent application.

After the crushed glass 40 has the desired size for use in the sealcoat 20, the crushed glass 40 is purified (cleaned) utilizing a washing process and/or heat process. The washing process is well-known in the recycling industry and involves washing the crushed glass 40 with a liquid cleaner to remove non-glass particles (e.g. labels). The purification of the crushed glass 40 is preferably performed using a heat process such as applying heated air at high temperatures to the crushed glass 40 to sterilize and remove the non-glass particles from the glass by burning the non-glass particles (e.g. labels). The purified glass is then tumbled and screened through a mesh to ensure the proper size of crushed glass 40 is provided. The size of the crushed glass 40 may vary depending upon the application and is preferably the same or similar size as conventional silica sand used in conventional sealcoatings.

### E. Mixer.

The mixer 70 may be comprised of any conventional sealcoating mixing equipment capable of mixing the sealer 30, crushed glass 40, water 50 and additive 60 together to form the sealcoat 20 in a liquid state. Various types of sealcoating mixing equipment may be used wherein a tank of the mixer 70 that receives the sealer 30, crushed glass 40, water 50 and additive 60 preferably mixes and agitates the sealcoating composition mechanically (hand or engine operated) or hydraulic agitation using a hydraulic pump. For smaller operations, the mixer 70 may be part of the sealcoating applicator 12 such as a tank on the sealcoating applicator 12.

### F. Sealcoat Composition

The sealcoat 20 is produced by combining a volume of sealer 30 (e.g. 100 gallons), the purified crushed glass 40 (e.g. 200-400 pounds), a volume of water 50 (30-60 gallons) and a volume of additives 60 (e.g. 2-5 gallons) into a mixer 70. The composition is mixed thoroughly to ensure even distribution of the purified crushed glass 40 through the composition.

After the sealcoat 20 is produced by the mixer 70, the sealcoat 20 is then applied by the sealcoating applicator 12 to the surface to be sealed such as a road 14. The sealcoat 20 may be applied in various thicknesses depending upon the number of coats applied and the volume rate of the sealcoat 20 dispensed. After application of the sealcoat 20 to the surface, it typically takes only approximately 7 hours for the sealcoat 20 to cure upon the surface sufficiently to be used again. When dried, the sealcoat 20 typically will have a thickness of 11-13 mils.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1-20. (canceled)

21. A process for forming a sealcoating composition for an asphalt road, comprising:
providing crushed glass, wherein said crushed glass is comprised of recycled glass cullet derived from glass containers;
purifying said crushed glass to remove non-glass particles thereby forming purified crushed glass;
providing a sealer in a liquid state, wherein said sealer is comprised of an asphalt emulsion sealer, a coal tar emulsion sealer or oil based sealer; and
mixing said purified crushed glass with said sealer forming a sealcoating composition.

22. The process for forming a sealcoating composition for an asphalt road of claim 21, wherein said step of purifying said crushed glass is comprised of heating said crushed glass at a high temperature to sterilize and remove non-glass particles, wherein said non-glass particles includes labels attached to said glass containers prior to crushing.

23. The process for forming a sealcoating composition for an asphalt road of claim 21, wherein said step of purifying said crushed glass is comprised of washing said crushed glass with a liquid cleaner to remove non-glass particles.

24. The process for forming a sealcoating composition for an asphalt road of claim 23, wherein said step of purifying said crushed glass is comprised of heating said crushed glass at a high temperature to sterilize and remove non-glass particles.

25. The process for forming a sealcoating composition for an asphalt road of claim 21, wherein said step of mixing said purified crushed glass includes mixing at least one additive with said purified crushed glass and said sealer forming said sealcoating composition.

26. The process for forming a sealcoating composition for an asphalt road of claim 25, wherein said at least one additive is comprised of a latex rubberizing additive to help suspend said purified crushed glass within said sealer while said sealer is in said liquid state.

27. The process for forming a sealcoating composition for an asphalt road of claim 21, including the step of crushing a plurality of glass containers with a glass crusher to pulverize said plurality of glass containers to a desired size thereby forming said recycled glass cullet.

28. The process for forming a sealcoating composition for an asphalt road of claim 27, including the step of screening said recycled glass cullet to said desired size.

29. The process for forming a sealcoating composition for an asphalt road of claim 28, wherein said desired size is between 20 to 75 mesh AFS.

30. A process for forming a sealcoating composition for an asphalt road, comprising:
crushing a plurality of glass containers with a glass crusher to pulverize said plurality of glass containers to a desired size thereby forming said recycled glass cullet;
screening said recycled glass cullet to said desired size, wherein said desired size is between 20 to 75 mesh AFS;
providing crushed glass, wherein said crushed glass is comprised of said recycled glass cullet;
heating said crushed glass at a high temperature to sterilize and remove non-glass particles thereby forming purified crushed glass;
providing a sealer in a liquid state, wherein said sealer is comprised of an asphalt emulsion sealer, a coal tar emulsion sealer or oil based sealer;
mixing said purified crushed glass with said sealer forming a sealcoating composition; and
applying said sealcoating composition to an upper surface of an asphalt road.

31. The process for forming a sealcoating composition for an asphalt road of claim 30, including the step of washing said crushed glass with a liquid cleaner to remove non-glass particles prior to forming said purified crushed glass.

32. The process for forming a sealcoating composition for an asphalt road of claim 30, wherein said step of mixing said purified crushed glass includes mixing at least one additive with said purified crushed glass and said sealer forming said sealcoating composition.

33. The process for forming a sealcoating composition for an asphalt road of claim 32, wherein said at least one additive is comprised of a latex rubberizing additive to help suspend said purified crushed glass within said sealer while said sealer is in said liquid state.

34. A process for forming a sealcoating composition for an asphalt road, comprising:
crushing a plurality of glass containers with a glass crusher to pulverize said plurality of glass containers to a desired size thereby forming said recycled glass cullet;
screening said recycled glass cullet to said desired size, wherein said desired size is between 20 to 75 mesh AFS;
providing crushed glass, wherein said crushed glass is comprised of said recycled glass cullet;
heating said crushed glass at a high temperature to sterilize and remove non-glass particles thereby forming purified crushed glass, wherein said non-glass particles includes labels attached to said glass containers;
providing a sealer in a liquid state, wherein said sealer is comprised of an asphalt emulsion sealer, a coal tar emulsion sealer or oil based sealer;
providing an additive, wherein said additive it comprised of a latex rubberizing additive to help suspend said purified crushed glass within said sealer while said sealer is in said liquid state;
mixing said purified crushed glass with said sealer and with said additive forming a sealcoating composition, wherein said sealcoating composition is mixed thoroughly to ensure even distribution of said purified crushed glass throughout said sealcoating composition; and
applying said sealcoating composition to an upper surface of an asphalt road.

35. The process for forming a sealcoating composition for an asphalt road of claim 34, including the step of washing said crushed glass with a liquid cleaner to remove non-glass particles prior to forming said purified crushed glass.
